(19) United States
(12) Patent Application Publication
(10) Pub. No.: US 2026/0006422 A1
(43) Pub. Date: Jan. 1, 2026

(54) A METHOD OF PROVIDING ALERTS AND NOTIFICATIONS IN EMERGENCY SITUATIONS

(71) Applicant: Shawn Daniel, Cicero, IL (US)

(72) Inventor: Shawn Daniel, Cicero, IL (US)

(21) Appl. No.: 19/236,093

(22) Filed: Jun. 12, 2025

Related U.S. Application Data
(60) Provisional application No. 63/665,310, filed on Jun. 28, 2024.

(51) Int. Cl. H04W 4/90; H04W 4/021; H04W 4/029; H04W 4/14; H04W 12/06

(52) U.S. Cl. CPC H04W 4/90; H04W 4/021; H04W 4/029; H04W 4/14; H04W 12/06

(57) ABSTRACT

A method of providing alerts and notifications in emergency situations is presented. A computer system including a network-connected platform having a graphical user interface provides alerts and notifications to authorized contacts by monitoring the spatial and time constrains of an authenticated user at a predetermined emergency facility. The alerts and notifications are generated once a monitoring module of a computer-implemented method verifies a user's location at a predetermined facility for a predetermined period of time and the user is unresponsive to an interval in an alert sequence.

### RELATED APPLICATIONS

This application claims priority to U.S. Provisional Patent Application Ser. No. 63/665,310 filed Jun. 28, 2024, now pending.

### FIELD OF THE INVENTION

The present disclosure is directed towards a method of providing alerts and notifications in emergency situations. More particularly, the subject matter is the means by which the alerts and notifications are generated once a monitoring module of a computer-implemented method verifies a user's location at a predetermined facility for a predetermined period of time and the user is unresponsive to an interval in an alert sequence.

### BACKGROUND OF THE INVENTION

This disclosure envisions the creation of an innovative portal tailored for the United States and international markets, complementing the all-in-one native mobile application. This portal will feature a robust backend system to streamline operations and enhance user experiences. Administrators will have the capability to efficiently manage a wide range of functionalities, including, packages, pricing structures, and user transactions.

With a user-centric design, the admin module aims to provide comprehensive control over the platform's offerings, ensuring seamless integration of diverse legal consultancy services, a medical alert system, and a secure document vault. By centralizing the management of these vital features, administrators can effectively monitor and optimize the services provided to users, thereby enhancing the overall efficiency and effectiveness of the platform.

The integration of the admin module within the project's ecosystem signifies a commitment to delivering a holistic solution that not only caters to the individual needs of users but also empowers administrators to uphold operational excellence and service quality in the dynamic landscape of legal consultancy and emergency assistance services in the United States and international markets.

To this end, a method of providing alerts and notifications in emergency situations is disclosed. The computer system includes a network-connected platform having a graphical user interface and a plurality of computer system modules including an authorized contacts module and an admin module. The method of providing alerts and notifications in emergency situations is further characterized with the following novel features: (1) Transmitting, by the computer system, a graphical user interface to a user device, wherein the graphical user interface displays elements for interacting with a plurality of computer system modules; (2) Wherein after receiving, by the computer system, a request for user access and user credentials from a plurality of user devices in the login authentication module, a list of authorized contacts pertaining to a user is received and the list is further associated with completed consent forms and a list of authorized contacts is correlated to a plurality of predetermined emergency encounters and consultancy services; and (3) Generation of alerts and notifications wherein a monitoring module with a computer-implemented method includes providing a user interface with at least two action intervals, monitoring user responses to the interfaces, initiating a timer upon user inactivity after the action intervals are presented, automatically progressing to a third interval if neither action intervals are selected within a predetermined period of time, and location verification of the user's presence at a predetermined emergency facility during the third interval.

### SUMMARY

It is therefore an advantage of the present invention to provide a method of providing alerts and notifications in emergency situations. In an embodiment, a computer system including a network-connected platform having a graphical user interface and a plurality of computer system modules provides alerts and notifications to authorized contacts when a monitoring module with a computer-implemented method is triggered in accordance with a triggering criteria of: (1) An authenticated user is inactive for at least two action intervals provided on a user interface; (2) The monitoring module automatically progresses to a third interval within a predetermined period of time; and (3) The user's location is verified at a predetermined emergency facility during the third interval.

It is an additional advantage of the present invention to provide a method of providing alerts and notifications in emergency situations, comprising: a computer system that includes a network-connected platform having a graphical user interface and a plurality of computer system modules including a user login authentication module, information modules, live session modules, account profile modules, authorized contacts modules, monitoring modules, notification modules, and an admin module.

It is an additional advantage of the present invention to provide a computer system receiving a list of authorized contacts pertaining to a user and the computer system associating the list of authorized contacts to a completed consent form, and correlating the list of authorized contacts to a plurality of emergency encounters and consultancy services.

It is an additional advantage of the present invention to provide a computer system having a location verification feature on a user interface for interval tracking of a user's location and wherein the computer system compares a user's current location to the location of predetermined emergency facilities.

It is still an additional advantage of the present invention to provide a computer system having a boundary check feature on a user interface and wherein the computer system verifies the user's presence within a specified geographical boundary of a predetermined emergency facility

It is still an additional advantage of the present invention to provide a computer system wherein the computer system configures a monitoring module to detect when a location verification feature confirms that a user is confined for a predetermined period of time in at least one of the predetermined emergency facilities.

It is still an additional advantage of the present invention to provide a computer system wherein the computer system configures a monitoring module to detect when a location verification feature confirms that a user is confined within a specified boundary of at least one of the predetermined emergency facilities.

It is still an additional advantage of the present invention to provide a computer system wherein the computer system configures an alert module to automatically send alerts to authorized contacts and authorized service personnel based on the user's current location at a predetermined location after tracking for a predetermined period of time.

It is still an additional advantage of the present invention to provide a computer system wherein the computer system generates alerts by a monitoring module and generates requests for specific user information if the monitoring module detects the user at a predetermined location for a predetermined period of time.

It is still an additional advantage of the present invention to provide a computer system for generating alerts by a monitoring module and the computer system generates requests for specific user information if the monitoring module detects the user in at least one specified boundary of a predetermined emergency facility for a predetermined period of time.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting.

In case of conflict with terms used in the art, the present specification, including definitions, will control. The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF THE DRAWINGS

The present embodiments are illustrated by way of the figures of the accompanying drawings, which may not necessarily be to scale, in which like references indicate similar elements, and in which:

FIG. 1 is a flow chart illustrating the computer system architecture, data flow, and user interface components for the method of providing emergency alerts and notification as described herein;

FIG. 2 is a flow chart illustrating the process flow of the notifications and alerts of the computer system as described herein;

FIG. 3 is a flow chart illustrating the user pathway of a guest user within the computer system;

FIG. 4 is an exemplary graphical user interface showing the plurality of consultancy services in accordance with the computer system provided herein;

FIG. 5 shows exemplary alerts and consent forms in accordance with the computer system provided herein;

FIG. 6 illustrates an exemplary graphical user interface showing the selection of an exempt location in accordance with the computer system provided herein;

FIG. 7 is a flow chart delineating the logged-in pathway of a client within the computer system;

FIG. 8 is a flow chart depicting a logged-in user flow in the computer system, illustrating the sequence of action performed by a user post-login;

FIG. 9 is a comprehensive flowchart illustrating the interaction between a third party and the legal alert functionalities of the computer system;

FIG. 10 is a continuation of FIG. 9 showing the comprehensive flowchart and illustrating the interaction between a third party and the legal alert functionalities of the mobile application;

FIG. 11 illustrates an exemplary citizen user's information screen wherein the citizen user enters personal information in the computer system;

FIG. 12 is an illustrative web-based dashboard wherein a user views all selected emergency facilities as provided herein;

FIG. 13 is continuation of FIG. 12 illustrating a web-based dashboard wherein a user views all selected emergency facilities as provided herein;

FIG. 14 is an illustrative web-based dashboard wherein a user selects a plurality of emergency facility as provided herein;

FIG. 15 is an illustrative web-based dashboard wherein a user selects an emergency facility from a multi-state selection option as provided herein;

FIG. 16 is an illustrative web-based dashboard wherein a user updates an assignment of an emergency facility from a multi-state selection option as provided herein;

FIG. 17 illustrates a graphical user interface for defining a boundary for a predetermined location as provided herein;

FIG. 18 illustrates a user interfaces within the computer system for setting up and confirming a boundary around an emergency facility in a designated state;

FIG. 19 displays a user interface within the computer system signaling the completion of defining a location boundary for a specific hospital;

FIG. 20 is an exemplary user interface within the computer system enabling the user to access and purchase consultancy services;

FIGS. 21-25 are exemplary user interfaces within the computer system showing a user engaging with various types of consultancy services following receipt of an emergency alert;

FIG. 26 illustrates a process flow diagram illustrating the method of implementing the alerts and notifications in emergency situations and the modules being associated therewith; and

FIG. 27 is a block diagram of a method of storing data associated with location data, alerts, and notifications according to an embodiment described herein.

### DETAILED DESCRIPTION

The following detailed description is a contemplated mode of carrying out a method of providing alerts and notifications in emergency situations as provided herein. Although the method is explained in relation to an illustrated embodiment, it is understood that many possible modifications and variations can be made without departing from the spirit and scope of the disclosure.

Therefore, the method of providing alerts and notifications may be used by a plurality of individuals having a plurality of emergency situations in any predetermined location. For example and without limitations, the predetermined locations as provided herein can be urban settings such as city streets, public transportation hubs like train stations and airports, and large public venues such as stadiums, concert halls, and convention centers. It can also be employed at private residences, workplaces, schools, hospitals, and healthcare facilities, as well as in outdoor environments like parks, hiking trails, or remote rural areas. Critical infrastructure sites such as utility plants, water treatment facilities, and transportation infrastructure (bridges, tunnels, and railways) may also benefit from this system to ensure safety and rapid response. Additionally, locations with high population densities or vulnerable populations, such as elderly care homes or refugee shelters, are prime candidates for deploying this system to enhance emergency preparedness and response.

It can be appreciated that implementation of a method of providing alerts and notifications in emergency situations can include user devices 128 capable of displaying a graphical user 104 from a computer system 100. The user device 128 as provided herein is depicted as a smart phone, but it will be understood that any other user devices capable of displaying a graphical user interface 104 may be utilized for tracking an authenticated user. Examples as provided herein may include, but are not limited to, smart watches, laptops, tablets, personal computers, televisions, fitness trackers, and the same for implementation of the method of providing alerts and notifications in emergency situations and as provided herein.

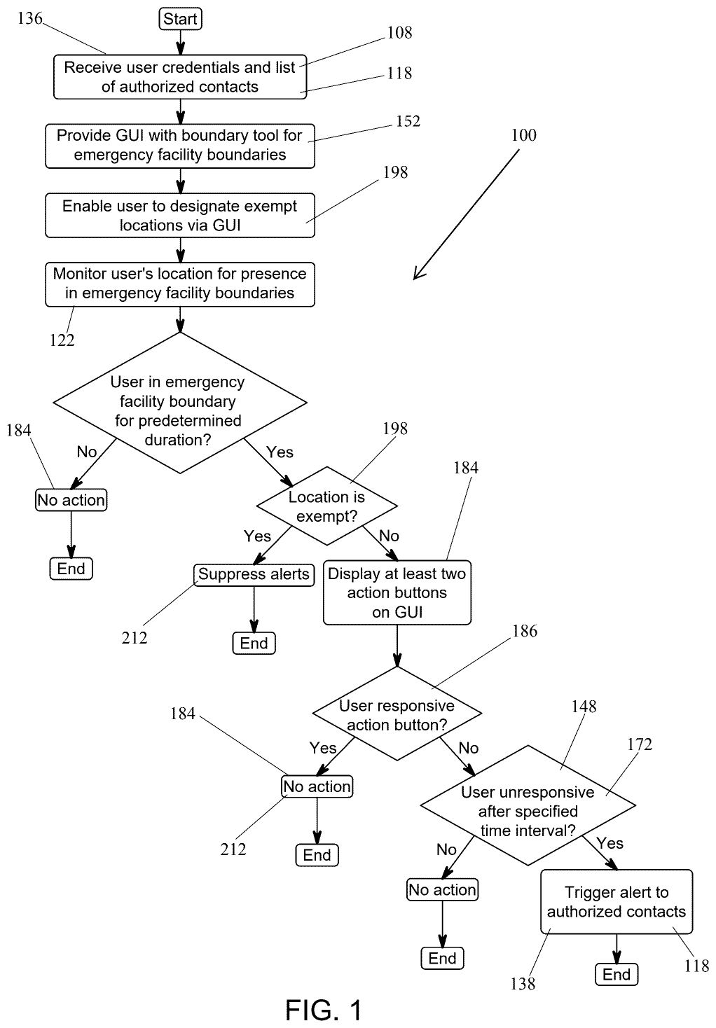

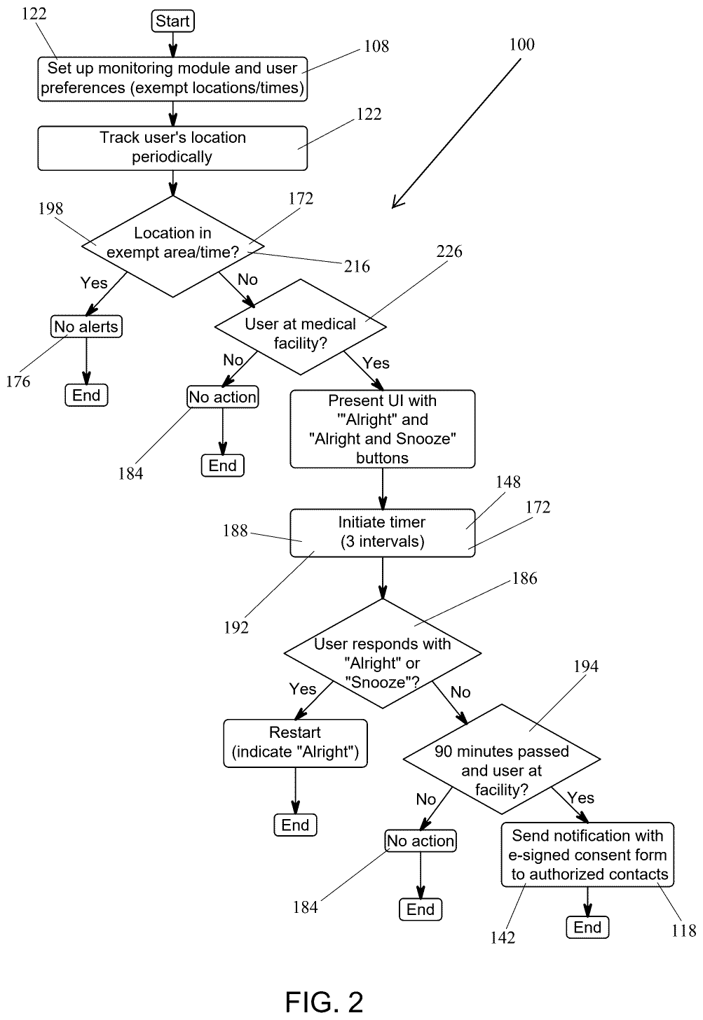

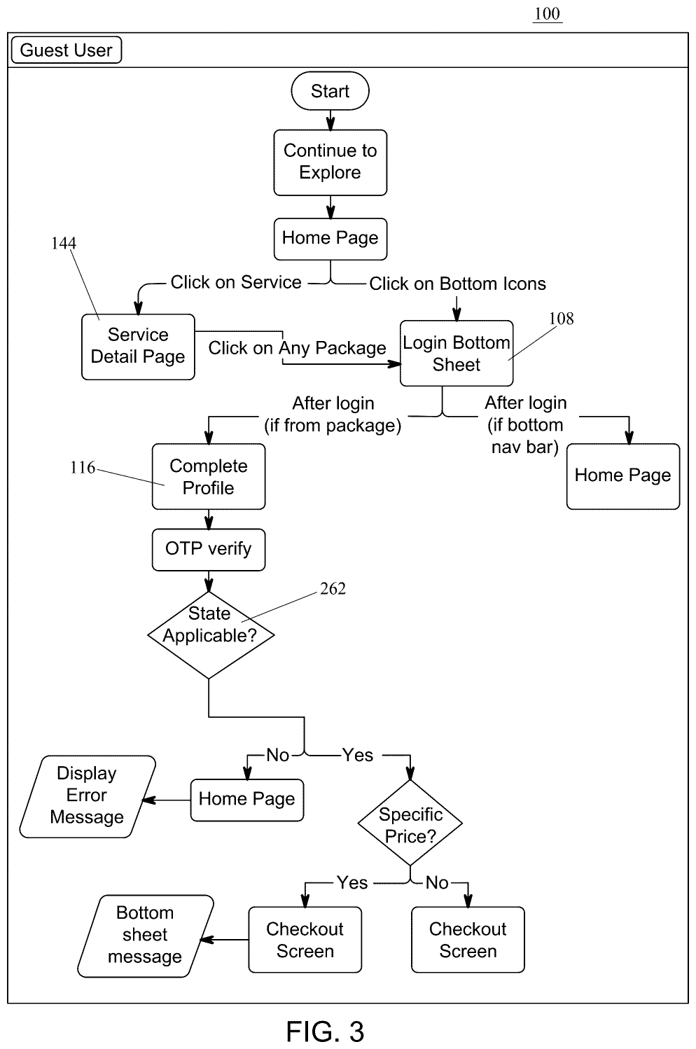

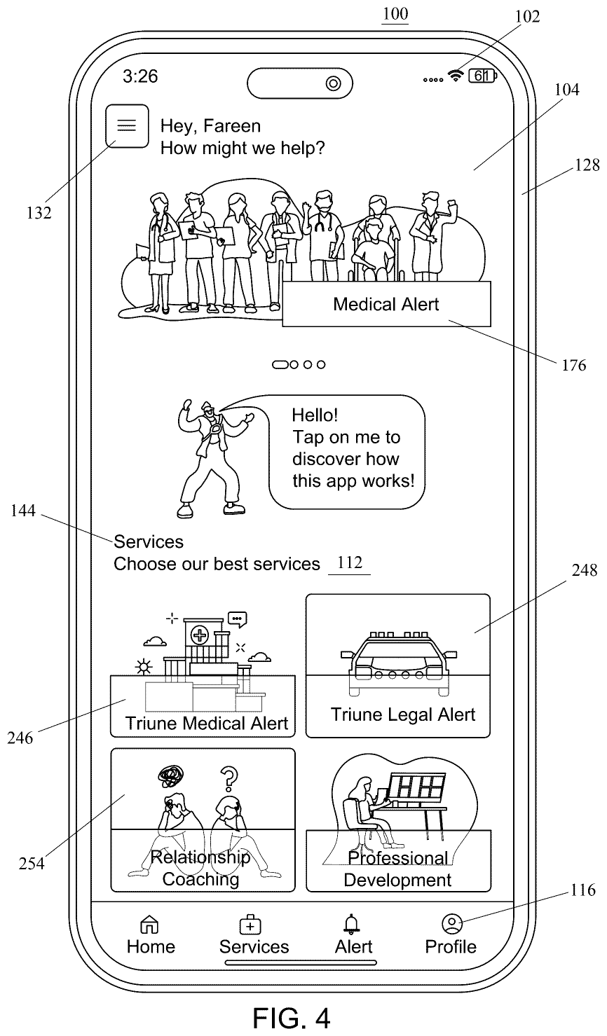

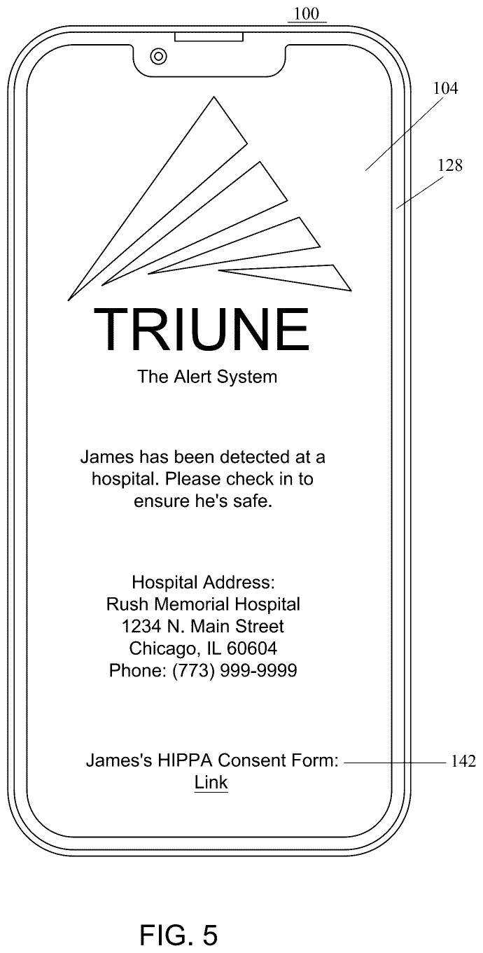

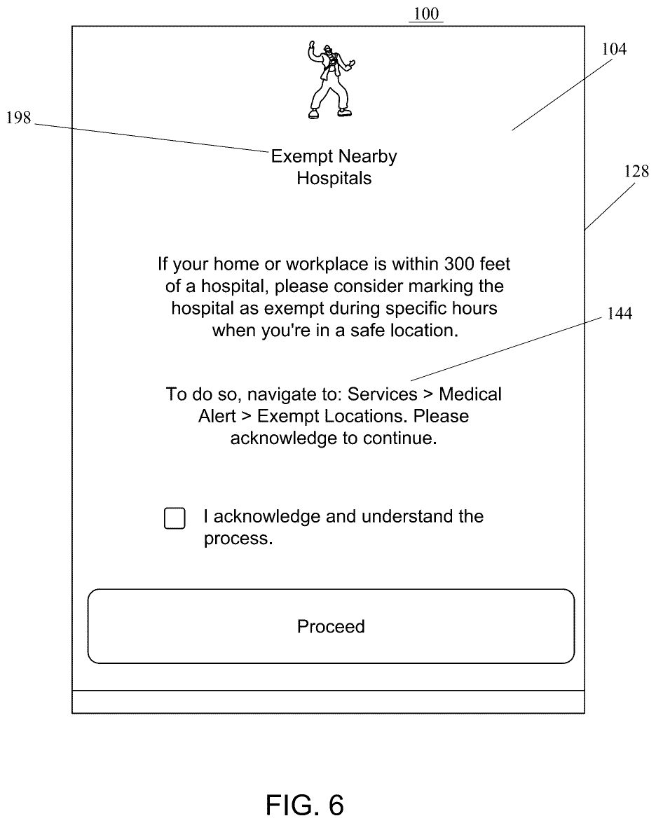

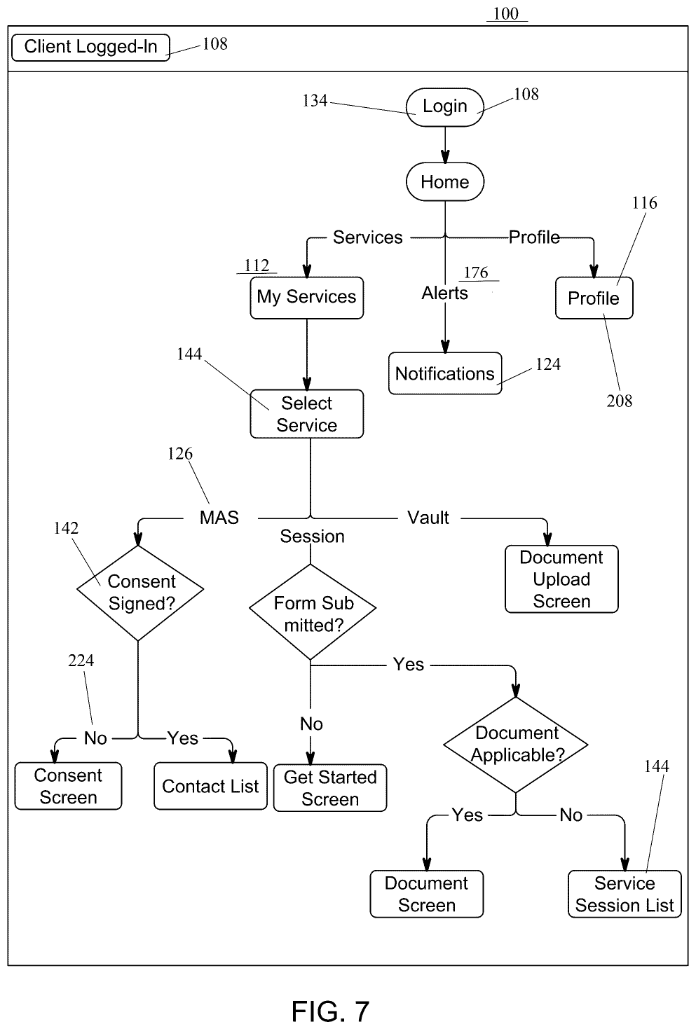

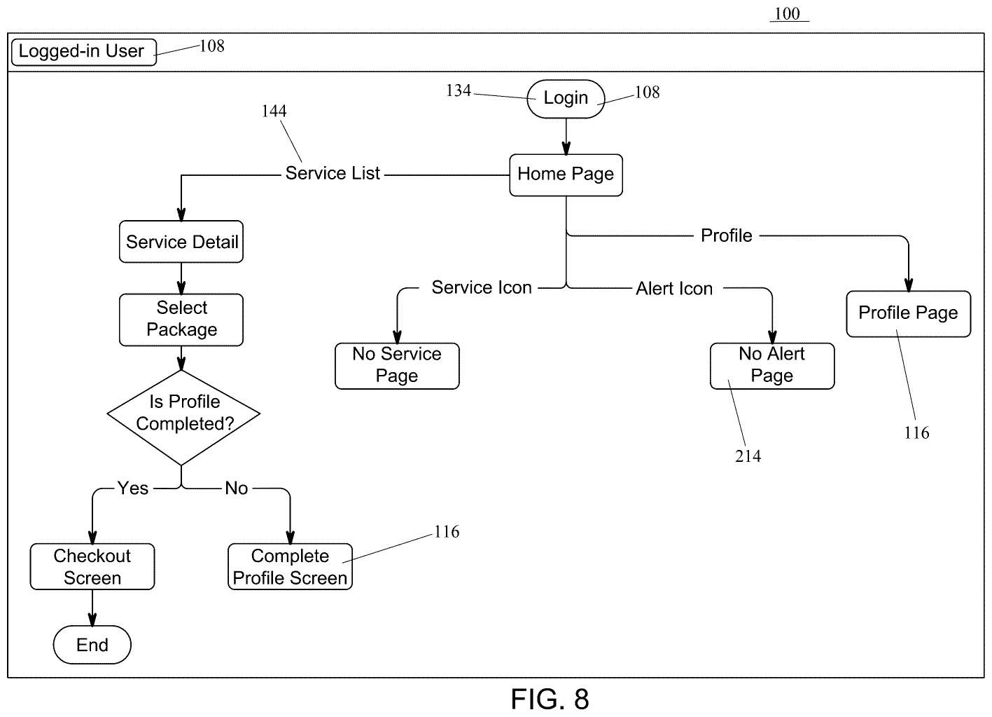

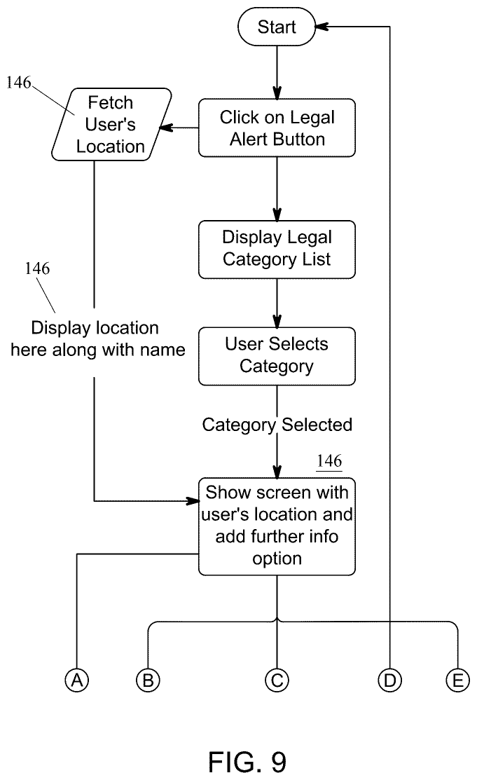

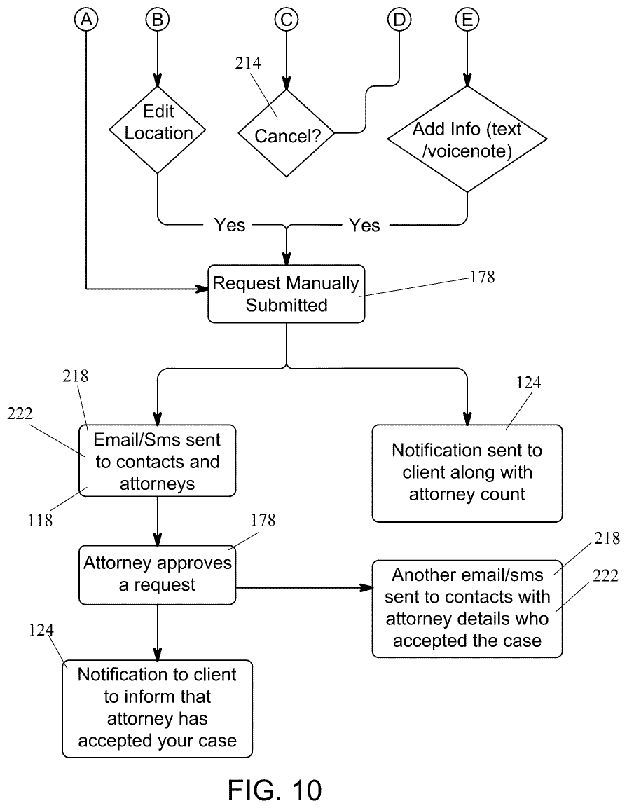

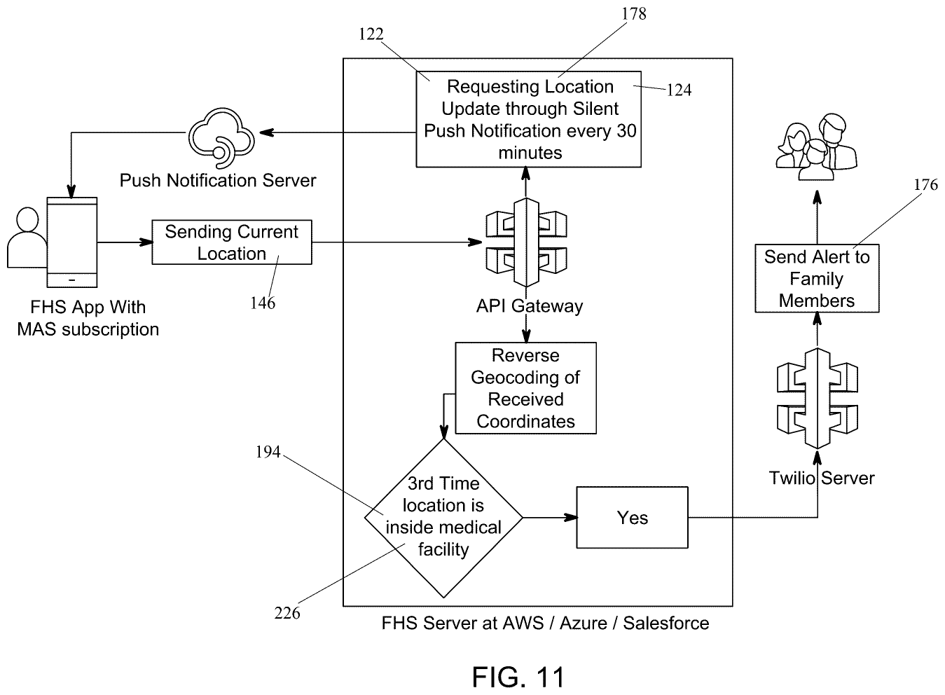

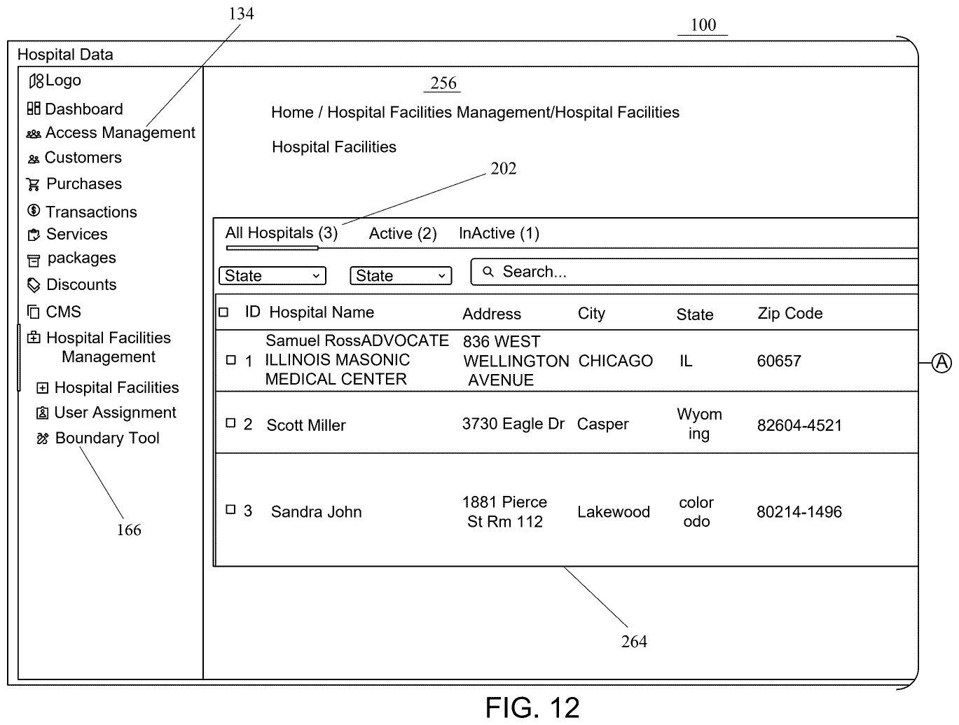

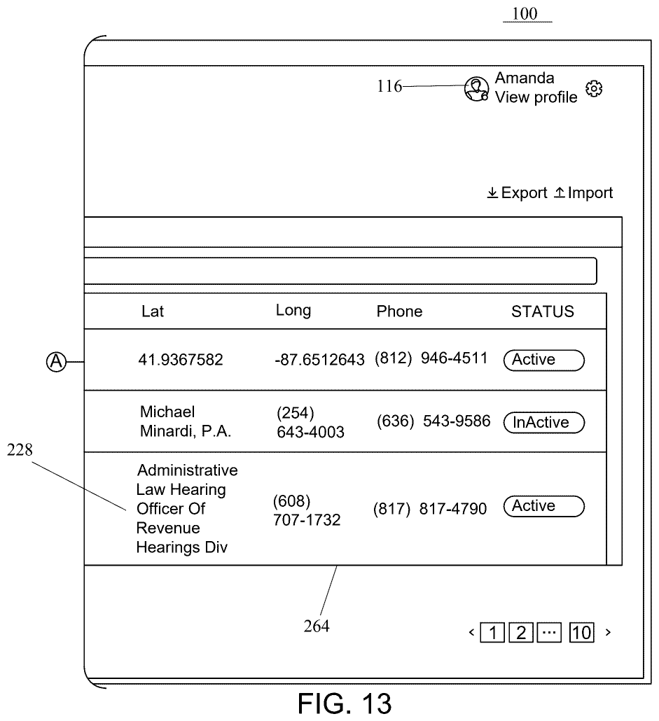

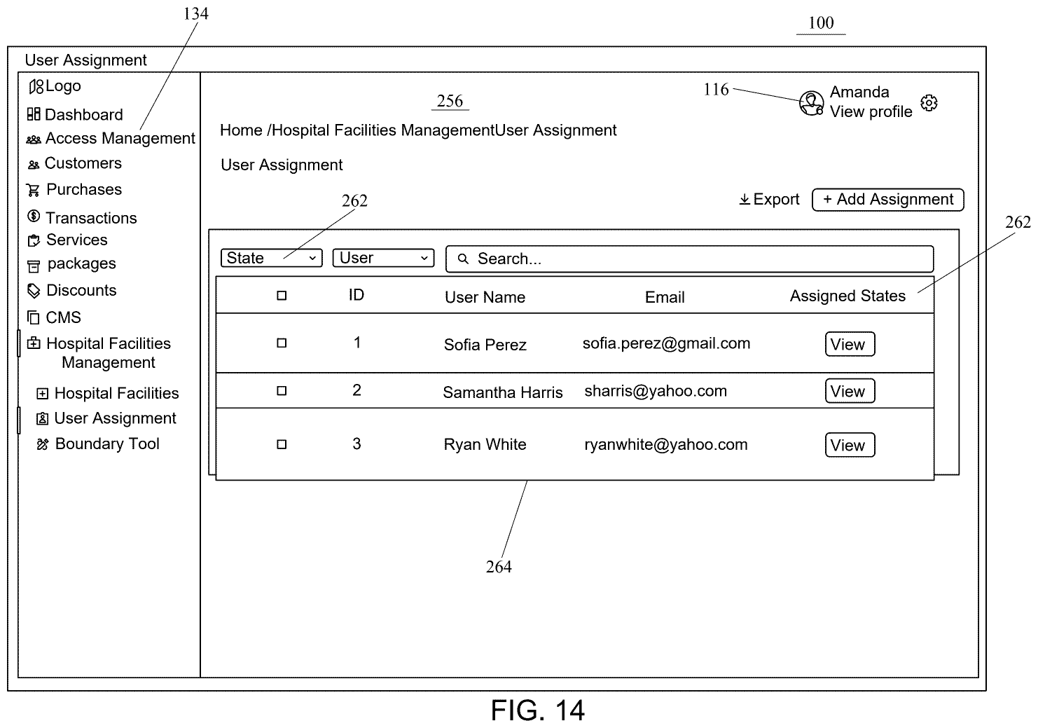

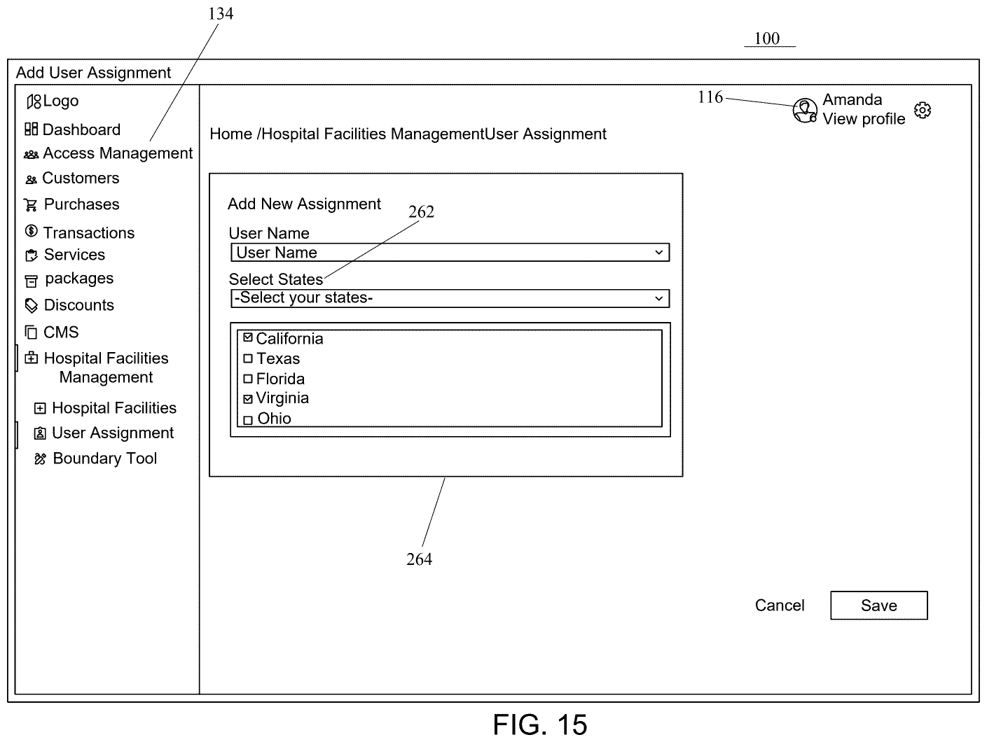

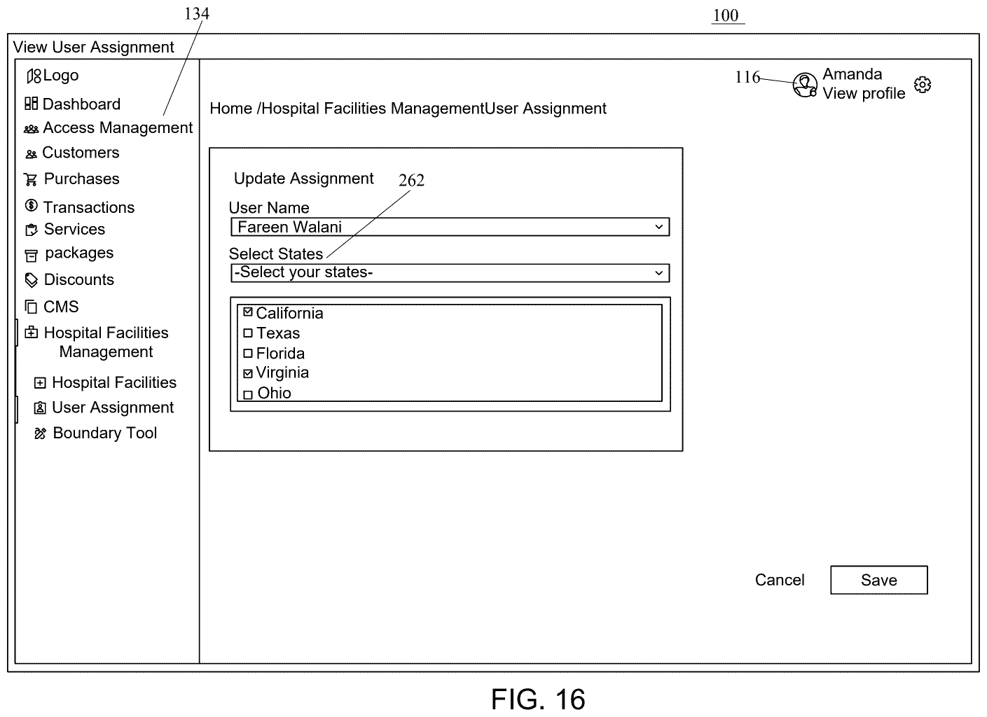

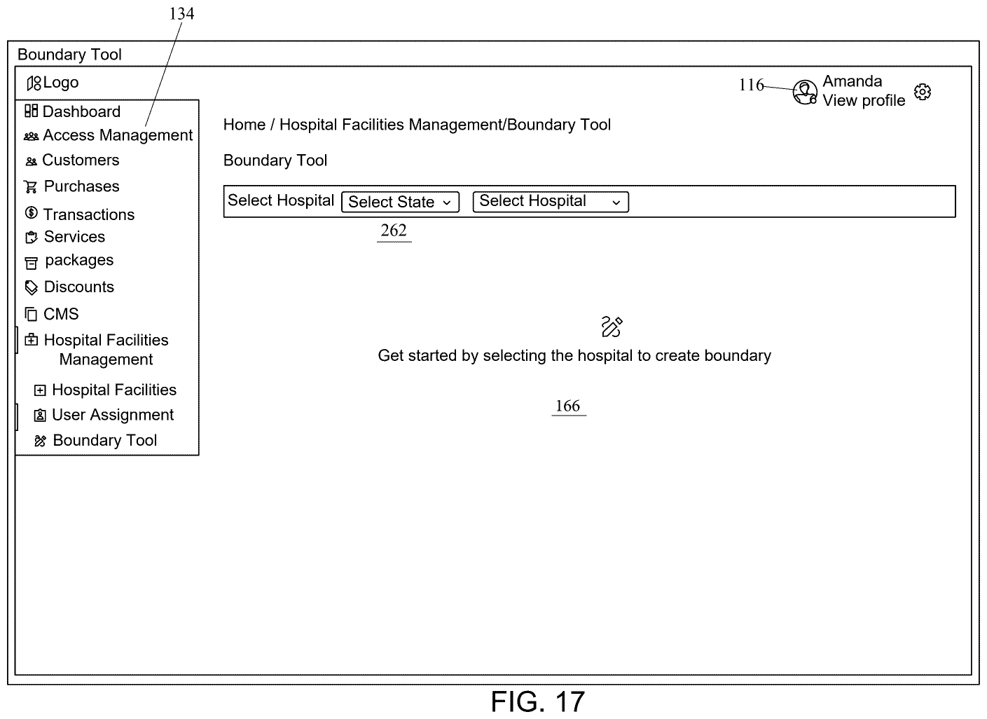

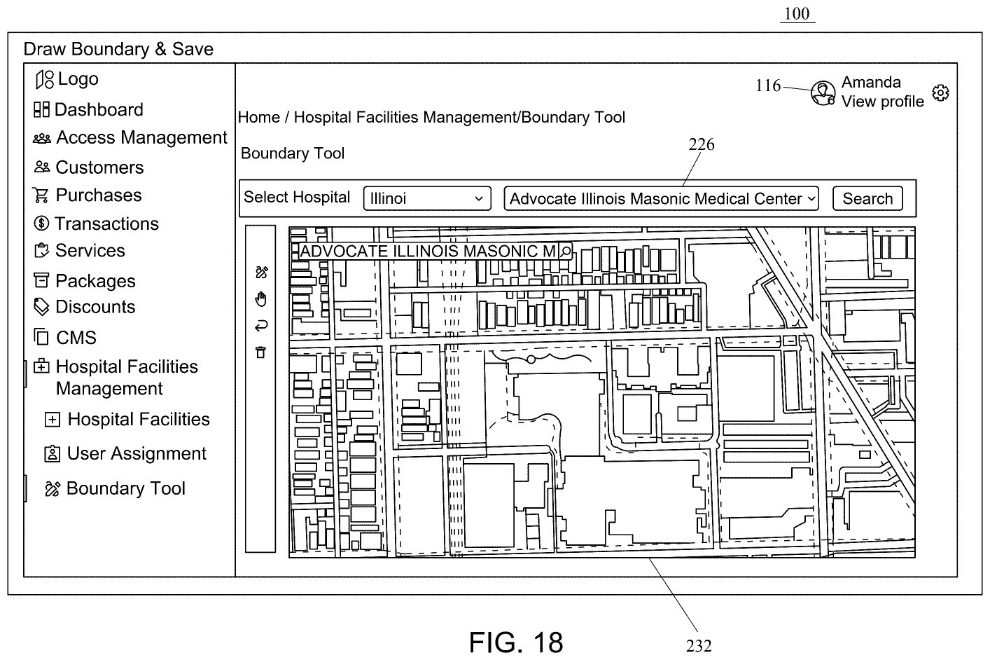

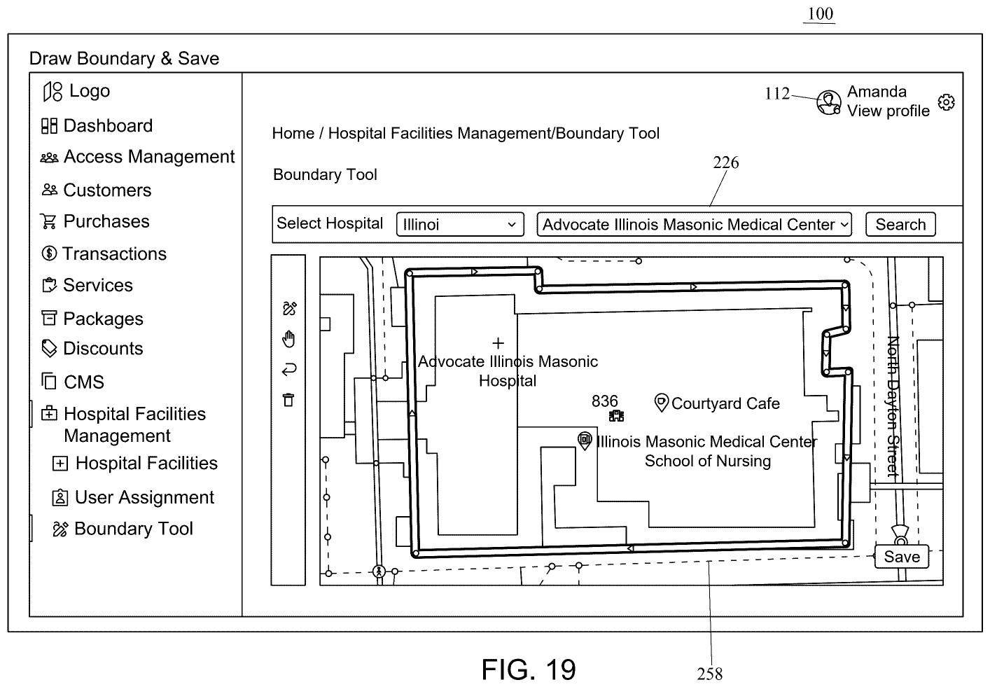

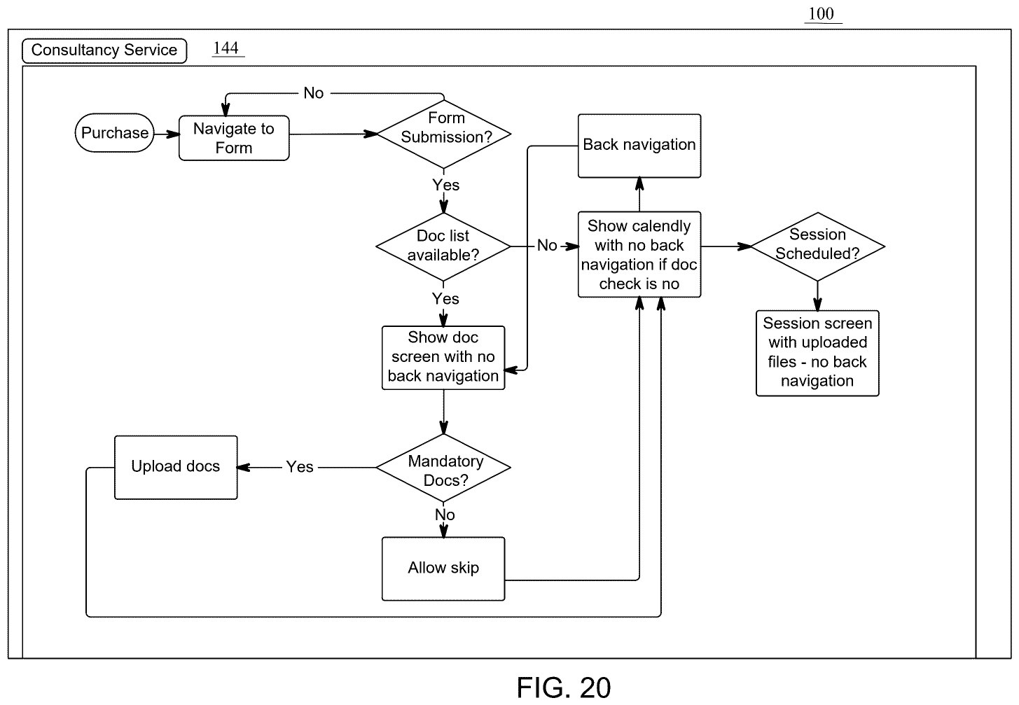

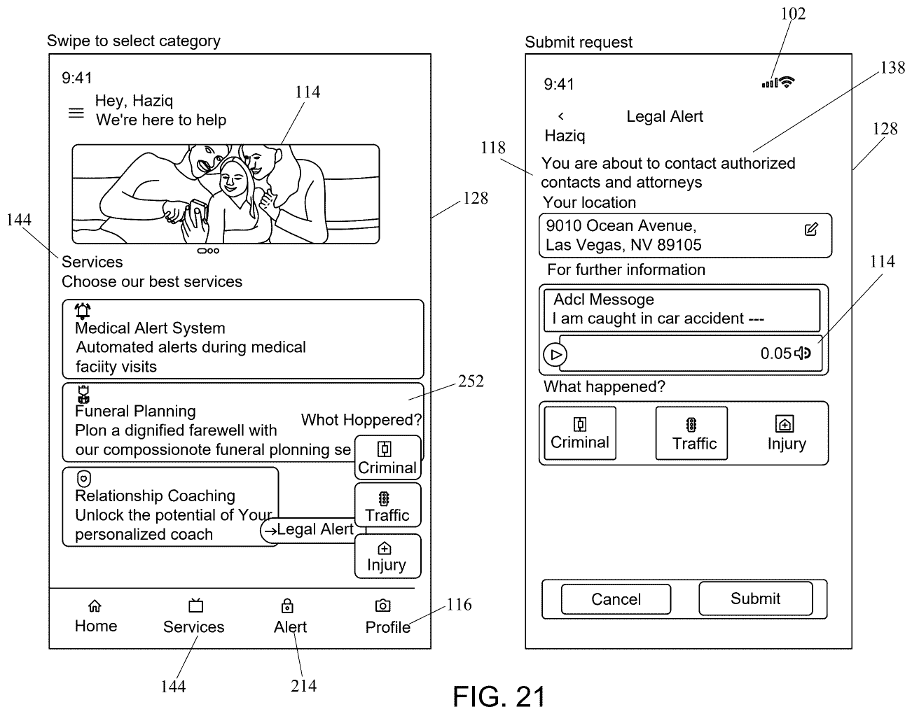

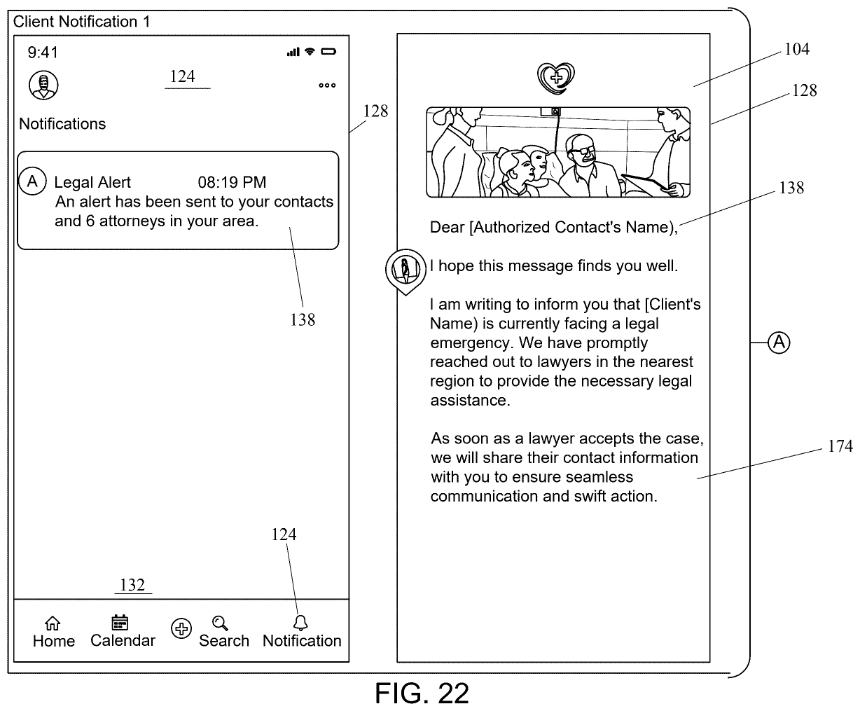

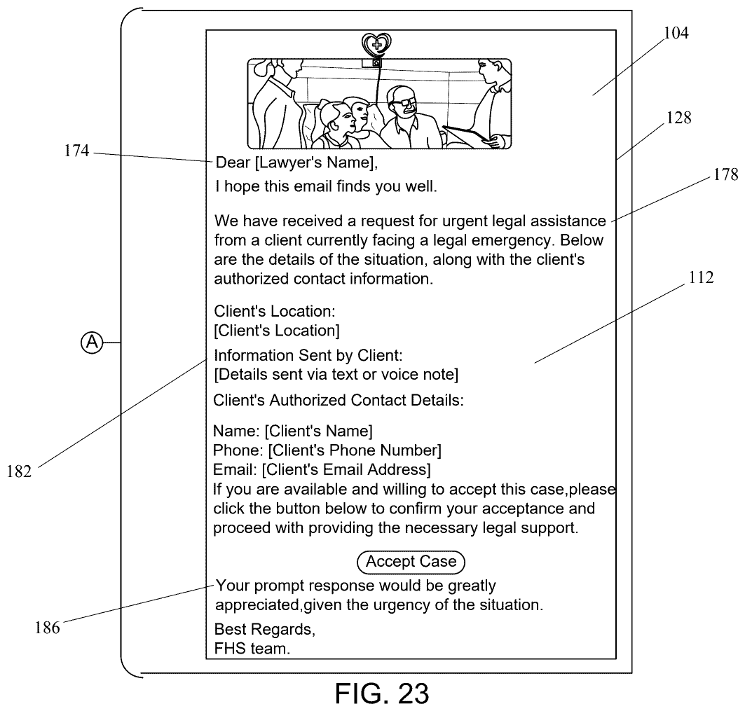

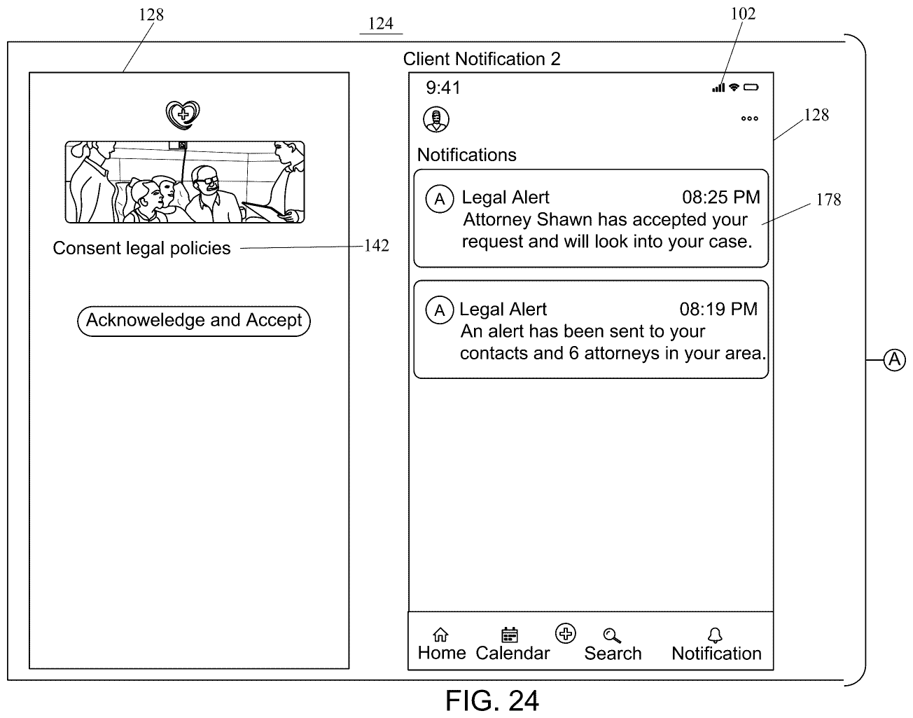

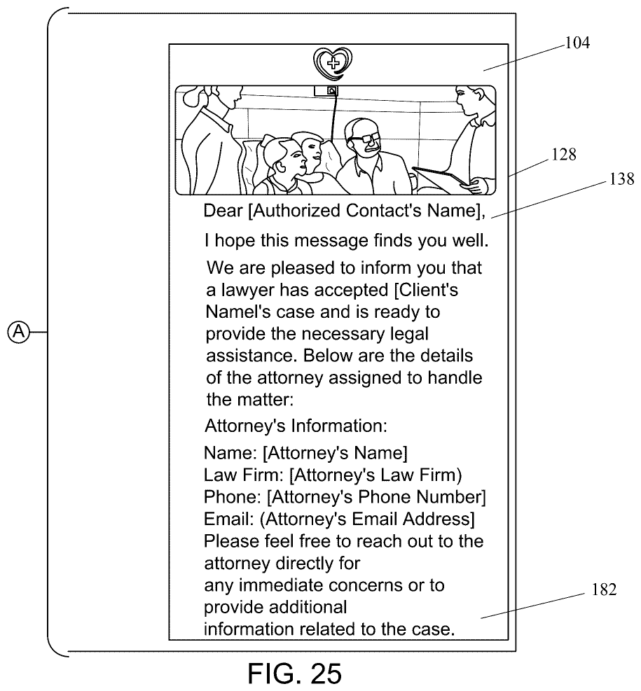

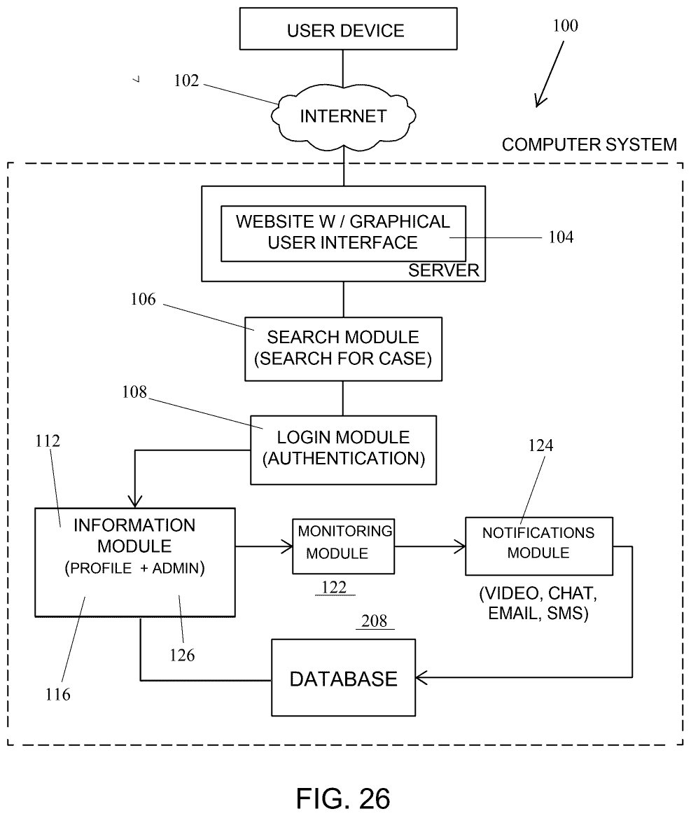

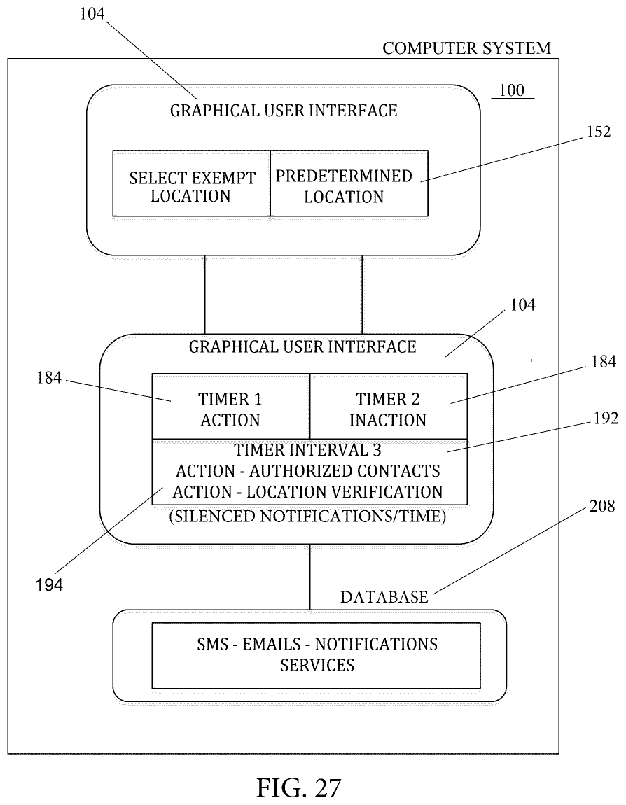

Referring now to FIGS. 1 and 2, the method of providing alerts 176 and notifications in emergency situations according to one embodiment of the present disclosure comprises a computer system 100 that includes a network-connected platform 102 having a graphical user interface 104 and a plurality of computer system modules 106 including a user login authentication module 108, information modules 112, live session modules 114, account profile modules 116, authorized contacts modules 118, monitoring modules 122, notification modules 124, and an admin module 126.

The computer system 100 further comprising the function of transmitting the graphical user interface 104 to a user device 128, wherein the graphical user interface 104 displays elements 132 for interacting with a plurality of computer system modules.

The interactive elements 132 are designed to facilitate user engagement and efficient operation of the computer system provided herein. These elements can comprise login fields such as username and password inputs, along with secure authentication controls. Once logged in, users are presented with a dashboard featuring navigation icons and status indicators for the computer system modules 106 described herein including elements 132 for profile management, location monitoring, notifications, and emergency contacts.

The computer system 100 receives a request 178 for user access 134 and user credentials 136 from a plurality of user devices 128 in the user login authentication 108 module and thereby creates user credentials 136 in response to the request 178 for credentials 136 thereof. The computer system 100 authenticates user credentials 136 in the user login authentication module 108 and is further adapted to receive a list of authorized contacts 138 pertaining to a user and associates the list of authorized contacts 138 to a completed consent form 142, and correlates the list of authorized contacts 138 to a plurality of emergency encounters and consultancy services 144. The consultancy services 144 include at least one of medical services 246, conflict resolution services 248, funeral planning services 252, or relationship coaching 254. Additional consultancy services 144 can include childcare services, suicide prevention services, or the same to facilitate effective intervention for the user and expedite proceedings as provided herein.

Examples of emergency encounters include medical emergencies, security threats (such as active shooter situations), fires, natural disasters (such as flood or earthquakes), and vehicle accidents. These emergency encounters encompass a range of critical situations that can occur at predetermined locations provided herein. The computer system 100 can thereby be enhanced, along with the admin module 126, to improve the safety and well being of individuals in diverse scenarios.

A graphical user interface 104 is provided with a location verification feature 146 thereon for interval tracking 148 of a user's location and wherein the user's current location is compared to the location of predetermined emergency facilities. The user interface 104 is further provided with a boundary check feature to verify the user's presence within a specified geographical boundary 258 of the predetermined emergency facility and the monitoring module 122 is configured to detect when the location verification 146 confirms that a user is confined for a predetermined period of time in at least one of the predetermined emergency facilities 152. The monitoring module 122 detects when the location verification 146 confirms that a user is confined within a specified boundary 258 of at least one of the predetermined emergency facilities 152.

The alert module automatically sends alerts 176 to the authorized contacts 138 and authorized service personnel 174 based on the user's current location at a predetermined location and after tracking for a predetermined period of time. The alert module automatically generates alerts 176 and generates requests 178 for specific user information 182 if the monitoring module 122 detects the user in at least one of the specified boundaries of the predetermined emergency facilities for a predetermined period of time.

Beyond lawyers and doctors, the system can include emergency responders such as paramedics, fire fighters, law enforcement officers, and rescue personnel. Additionally, technical support staff, security guards, and social workers may be relevant depending on the context and the requirement for an authorized service personnel 174. Their location is critical, as it allows the system to coordinate timely assistance by dispatching the nearest or most appropriate personnel to the user's predetermined emergency facility 152.

Specific user information 182 in the context of tracking may include personal details such as user identity as well as location data collected through GPS or other geolocation services. Additionally, it encompasses specific locations 202 and associated emergency and consultancy services 144 relevant to those locations. This comprehensive user information enables the system to monitor user movements, quickly identify relevant emergency facilities, and facilitate timely notifications and assistance tailored to the user's specific needs and environments.

The monitoring module 122 is therefore provided with a computer-implemented method comprising of providing a user interface 184 with at least two action buttons 184, monitoring user responses 186 to the interface 184, initiating a timer 188 upon user inactivity after the action buttons are presented on the graphical user interface 104, automatically progressing to a third interval 192 if neither action buttons 184 are selected within a predetermined period of time, verifying the user's presence at a predetermined emergency facility 152 during the third interval 192, triggering a notification 194 to the authorized contacts 138 if the user remains at the predetermined emergency facility 152 during the third interval 192, and restarting the timer 188 countdown upon user response 186 to alerts 176 by depressing at least one action button 212.

The boundary check feature may include an exempt location 198 wherein specific locations 202 are designated for predetermined periods of time 172 as exempt 198. The graphical user interface 104 can include a map feature 232 allowing the user to designate exempt locations 198 by placing a geographical pin 234. Therefore, the exempt locations 198 are predetermined and can include specific sites such as hospitals, emergency shelters, police stations, or designated service centers, where users may need to remain or transit during certain periods. For example, and without limitations, a user visiting a hospital for medical treatment can decide to be temporarily outside their usual specified geographic boundary 256 limits. Similarly, during scheduled maintenance or community events, certain public venues like stadiums or convention centers could be marked as exempt 198 for specific time windows. Therefore, the exempt location 198 is configured with specific start and end times and days of the week. This flexibility ensures that users are not erroneously flagged in predefined areas during legitimate activities or authorized visits. This reduces false alarms and enhances the system's reliability in emergency response management.

For example, and without limitations, the user can set preferences for specific hours or to silence alerts 176 for defined periods of time. Upon selecting preferences for specific times, the user can select start/end times along with days such as: Mon to Fri, 9 am-6 pm. This functionality is particularly beneficial for situations where users frequently visit places that do not require emergency alerts, fostering a more nuanced and user-centric alert system. In defining the exact exempt locations 198, the users can place a geographical pin on a map 232 provided in the graphical user interface 104. This ensures accuracy in identifying the exempt location 198.

The information modules 112 include the location of predetermined emergency facilities 152, geographical boundaries of the predetermined emergency facilities 152, and consultancy services 144. This data can be obtained through integration with external databases 208, geographic information system (GIS) platforms, or manual data entry by authorized administrators 126. The computer system 100 may regularly update this information via direct input from the user to ensure accuracy and timeliness. The geographical boundaries of emergency facilities are mapped using coordinate data, which delineates the physical extent of each facility's service area. Additionally, details about available consultancy services 144, such as medical, legal, or mental health assistance, are stored within the modules, enabling quick retrieval and reference during emergency situations. The data is securely stored in the computer system's database 208, with appropriate access controls and periodic validation procedures to maintain data integrity, accuracy, and relevance, ensuring that users and emergency responders have reliable information at all times.

The monitoring module 122 tracks the user's location at predetermined time intervals 206 and stores the location data in a database 208. This location data is securely transmitted to the computer system 100 and stored within a dedicated database 208 designed for temporal and spatial data management. Each recorded location entry can include timestamp information to establish a chronological trail of the user's movements. This stored data can be used to generate movement histories, verify whether the user remains within designated boundaries, or identify patterns of movement over time. During an emergency, the computer system 100 can quickly retrieve the most recent location data to assist authenticated contacts 138 in locating the user accurately.

Additionally, this location history can be analyzed to identify movement trends, assess exposure to risk zones, or verify compliance with boundary restrictions. Proper data encryption and access controls ensure user privacy and data security, while the stored location logs can provide valuable insights for emergency response planning and post-incident review.

The action buttons include a button 212 to indicate the user is not in distress and a button 214 to temporarily suspend 216 alerts 176 for a specified period 216. This button provides a quick way for users to communicate that they are temporarily away, which can be useful in reducing false alarms or unnecessary notifications during routine activities. Additionally, the specified period for suspending alerts 176 via an action button is user-configurable through the graphical user interface 104. Exemplary periods for suspending alerts 176 can include scheduled travel, family events, or other activities that are outside a predetermined boundary. The duration and activation of the suspended alerts 176 are customizable through the graphical user interface 104, ensuring flexibility based on individual needs or specific scenarios. During this suspension period, the computer system 100 halts automatic alerts 176 to authorized contacts 138. This prevents unnecessary notifications while the user is temporarily outside the boundary of the predetermined emergency facilities.

When an emergency or relevant event occurs, the notification module 124 is thereby enabled for sending alerts 176 to authorized contacts 138 via different channels depending on their location. The notification module 124 sends alerts 176 to the authorized contacts via SMS 218 for domestic contacts and via email 222 for international contacts and includes an option for the contacts to decline participation.

Both methods provide for immediate and direct communication. The system 100 also includes an option for contacts to decline participation in receiving alerts 176, which can be managed through the user interface 104. This feature ensures respect for user preferences and privacy while maintaining an effective communication flow during emergencies. In practical terms, when an alert is triggered, the system 100 automatically dispatches SMS 218 messages to domestic contacts, such as family or local emergency services, and emails 222 to international contacts, such as overseas family members or foreign assistance agencies, thereby facilitating rapid and appropriate response actions across different regions.

Further in the described method, the consent form 142 is electronically signed by the user and is attached to notifications sent to the authorized contacts 138. The consent form 142 authorizes the system 100 to access and share their personal information and location data during emergencies. This consent form 142 is securely signed via the graphical user interface 104 and is attached to notifications that are sent to the authorized contacts 138, ensuring that all parties are informed and have acknowledged the user's consent for emergency communication and data sharing. The signed consent form 142 not only facilitates rapid response efforts but also ensures compliance with privacy regulations and user preferences.

The predetermined emergency facilities encompass critical locations such as medical facilities 226 and law enforcement authorities 228. The system 100 maintains detailed information about these facilities, including their geographic locations and contact details, enabling quick access and coordination during emergencies. By incorporating these essential facilities into the system 100, the method ensures that users can be directed to the appropriate resources swiftly, and emergency responders can efficiently coordinate assistance to mitigate risks and provide timely aid.

In addition to medical facilities 26 and law enforcement authorities 228, the system 100 can incorporate a diverse range of critical locations essential for emergency responses in accordance with the method provided herein and user safety. These include schools, fire stations, prisons, emergency shelters, disaster response centers, poison control centers, mental health clinics, community resource centers, utility plants, transportation hubs, and government emergency management offices. The system 100 maintains detailed geographic and contact information for these locations, enabling it to quickly identify and facilitate communication with the nearest or most relevant facility based on the specific emergency. Importantly, the system 100 is designed to notify authorized contacts 138 such as family members, friends, or designated emergency contacts when the user interacts with or is directed to these critical locations. This ensures that authorized contacts 138 are kept informed of the user's status and location during emergencies. By maintaining a comprehensive database of these vital locations and facilitating communication with authorized contacts 138, the system 100 improves response times, user safety, and overall emergency management as provided herein.

In an embodiment, the computer system 100 tracks the user's location periodically and compares it to a database 208 of predetermined emergency facilities and verifies the user's presence within a geographical boundary of a predetermined emergency facility for a predetermined period. The user is presented a user interface with at least the two action buttons 184 to prompt user response 186. The timer 188 is initiated upon user inactivity after presenting the action button. An alert is generated to authorized contacts 138 if the user remains unresponsive and is located at the predetermined emergency facility after a third interval 192. A consent form 142 is attached to the alert to enable authorized contacts 138 to access user information and where the alert includes a request 178 for specific user information from the predetermined emergency facility. The graphical user interface 104 would thereby display a hospital assignment page 256 for assigning the user to specific medical facilities 226.

Another embodiment provided herein can include the system 100 tracking the user's location every 30 minutes and storing the data in a database 208. After two intervals (60 minutes), the system 100 can check if the user's location matches a medical facility 226. If so and without limitations, the system 100 can notify the user through push and in-app notifications to inquire about their health status.

For example, and without limitation, the monitoring module 122 may have at least three intervals wherein the user responds to the alerts 176 by depressing a “Safe” button or a “Snooze” button before authorized contacts 138 are contacted and the consent form 142 is attached to the notification. The two action buttons in an embodiment can be marked as “Alright” to indicate that the user is fine. A second indication of “Alright and Snooze” can allow the user to snooze alerts 176 for a specified time. If the user does not respond within the next 30 minutes and a total of 90 minutes have passed, the system 100 can check the third interval 192. If the user is still at the medical facility 226, the system 100 sends notifications to authorized contacts 138. A consent form 142, e-signed by the user during the initial setup, is attached to the notification. In exemplary responses, this form allows authorized contacts 138 to access the user's medical information from the hospital or relevant healthcare services. The system 100 restarts the timer 188 count if the user responds to the alerts 176 by depressing a “Safe” button or a “Snooze” button, and their health status is thereby indicated as “Alright”.

The method as provided herein can include alert integrated with a web-based 264 dashboard to consolidate user data from the graphical user interface 104 and track interactions with consultancy services 144. The information modules thereby include consent forms 142, the location of predetermined emergency facilities 152, geographical boundaries of the predetermined emergency facilities 258, predetermined consultancy services 144, and the same for an efficient administration of the system 100.

### Users, Emergency Encounters, and Authorized Contacts

Users can establish profiles by entering their information upon download and gaining access to the array of services. Additionally, a web-based dashboard 264 will be implemented to consolidate information from an exemplary mobile app and associated website, enabling tracking, trending, and storage of all data entered through both platforms.

Users must agree to key elements 132, including notifications based on proximity to medical facilities 226, geographical limitations, data collection, and data sharing. An exemplary sign-up screen can include a plurality of demographic information including their date of birth and current city. All aspects of client information can be modified including their list of authorized contacts 138. The subscription can be cancelled and the user can subsequently select to cancel a subscription by selecting “Delete Account” on the graphical user interface 104.

Emergency situations such as a health crisis or an encounter with a police officer require immediate attention and are often difficult to address. These situations pose extreme difficulties regardless of age and physical condition. The disclosure as provided herein seeks to address the need for third party intervention and assistance in emergency situations such as hospitalization and law enforcement encounters. As provided herein, authorized contacts 138 are individuals designated by the client to receive alerts 176 in case of emergency situations. Upon addition, the system 100 must send an SMS 218 to domestic authorized contacts or an email 222 to international authorized contacts, informing them about the user's consent along with an option to decline the invitation 224. In the case of a medical emergency, users can add close friends or family as authorized contacts 138 who will receive alerts 176 when the user is at a medical facility 226 for 90 minutes or shorter periods of time to resolve an emergency as provided herein.

Once an authorized contact within the network is warned, the contact can provide additional assistance as provided herein (a particularly critical element for proper medical and legal advocacy for ill or arrested individuals). Complete and separate forms for each consultancy service to which they seek assistance must be completed. A user therefore enters a form only once, and the data provided therein is shared by the authorized contact once the participation of the authorized contact is enabled through the spatial and time sequences required for notification. The information provided in each completed form is thereby forwarded to the appropriate consultancy and medical resolution service via the computer network. This disclosure thereby provides: (1) Spatial and time determinations as paramount to determining emergency situations and will issue automatic alerts 176 to authorized contacts 138; and (2) An established consent network for immediate assistance and the possibility of a more expedient process for achieving medical or legal advocacy.

Certain components necessary to the operation of this disclosure are not shown or described in detail because they are components well known to those in the relevant arts. These components can include requisite modules, dashboards, devices, databases, and similar components.

While the invention has been described in detail and with reference to specific embodiments thereof, it will be apparent to one skilled in the art that various changes and modifications can be made therein without departing from the spirit and scope thereof.

What is claimed is:

1. A method of providing alerts and notifications in emergency situations, comprising: a computer system that includes a network-connected platform having a graphical user interface and a plurality of computer system modules including a user login authentication module, information modules, live session modules, account profile modules, authorized contacts modules, monitoring modules, notification modules, and an admin module, the computer system further comprising:
transmitting, by the computer system, the graphical user interface to a user device, wherein the graphical user interface displays elements for interacting with a plurality of computer system modules;
receiving, by the computer system, a request for user access and user credentials from a plurality of user devices in the user login authentication module;
creating user credentials, by the computer system, in response to a request for credentials from a user in the user login authentication module;
authenticating the user credentials, by the computer system, in the user login authentication module;
receiving a list of authorized contacts pertaining to a user, by the computer system, associating the list of authorized contacts to a completed consent form, and correlating the list of authorized contacts to a plurality of emergency encounters and consultancy services;
providing a location verification feature on the graphical user interface, by the computer system, for interval tracking of a user's location and wherein the user's current location is compared to the location of predetermined emergency facilities;
providing a boundary check feature on the graphical user interface, by the computer system, to verify the user's presence within a specified geographical boundaries of the predetermined emergency facilities;
configuring the monitoring module to detect when the location verification confirms that a user is confined for a predetermined period of time in at least one of the predetermined emergency facilities;
configuring the monitoring module to detect when the location verification confirms that a user is confined within a specified boundary of at least one of the predetermined emergency facilities;
configuring an alert module to automatically send the alerts to the authorized contacts and authorized service personnel based on the user's current location at a predetermined location after tracking for a predetermined period of time;
generating the alerts by the monitoring module and generating requests for specific user information if the monitoring module detects the user at the predetermined location for a predetermined period of time;
generating the alerts by the monitoring module and generating requests for the specific user information if the monitoring module detects the user in at least one of the specified boundaries of the predetermined emergency facilities for a predetermined period of time;
providing the monitoring module with a computer-implemented method comprising: providing user interfaces with at least two action buttons, monitoring user responses to the interfaces, initiating a timer upon user inactivity after the action buttons are presented, automatically progressing to a third interval if neither action buttons are selected within a predetermined period of time, verifying the user's presence at a predetermined emergency facility during the third interval; triggering a notification to the authorized contacts if the user remains at the predetermined emergency facility during the third interval; restarting the timer countdown upon user response to the alerts by depressing at least one action button.

2. The method of claim 1, wherein the boundary check feature may include an exempt location wherein specific locations are designated for predetermined periods of time as exempt.

3. The method of claim 1, wherein the information modules include the location of the predetermined emergency facilities, geographical boundaries of the predetermined emergency facilities, and consultancy services.

4. The method of claim 1, wherein the monitoring module tracks the user's location at predetermined time intervals and stores the location data in a database.

5. The method of claim 1, wherein the action buttons include a button to indicate the user is not in distress and a button to temporarily suspend the alerts for a specified period.

6. The method of claim 5, wherein the specified period for suspending the alerts via an action button is user-configurable through the graphical user interface.

7. The method of claim 1, wherein the notification module sends the alerts to the authorized contacts via SMS for domestic contacts and via email for international contacts and includes an option for the contacts to decline participation.

8. The method of claim 1, wherein the consent form is electronically signed by the user and is attached to notifications sent to the authorized contacts.

9. The method of claim 1, wherein the predetermined emergency facilities include medical facilities and law enforcement authorities.

10. The method of claim 1, wherein the graphical user interface includes a map feature allowing the user to designate exempt locations by placing a geographical pin.

11. The method of claim 2, wherein the exempt location is configured with specific start and end times and days of the week.

12. The method of claim 1, wherein the consultancy services include at least one of medical services, conflict resolution services, funeral planning services, or relationship coaching.

13. A method of providing alerts in emergency situations, comprising:
providing a computer system with a network-connected platform and a graphical user interface for user interaction;
authenticating a user via a user login authentication module and associating a list of authorized contacts with the user;
tracking the user's location periodically and comparing it to a database of predetermined emergency facilities;
verifying the user's presence within a geographical boundary of a predetermined emergency facility for a predetermined period;
presenting a user interface with at least two action buttons to prompt user response;
initiating a timer upon user inactivity after presenting the action buttons;
generating an alert to authorized contacts if the user remains unresponsive and is located at the predetermined emergency facility after a third interval; and
attaching a consent form to the alert to enable authorized contacts to access user information.

14. The method of claim 13, wherein the alert includes a request for specific user information from the predetermined emergency facility.

15. The method of claim 13, wherein the graphical user interface displays a hospital assignment page for assigning the user to specific medical facilities.

16. A method of managing emergency notifications, comprising:
receiving, by a computer system, user credentials and a list of authorized contacts associated with a user;
providing a graphical user interface to a user device, the interface including a boundary tool for defining geographical boundaries around predetermined emergency facilities;
monitoring the user's location to detect presence within the defined geographical boundaries for a predetermined duration;
displaying at least two action buttons on the graphical user interface to prompt user interaction;
triggering an alert to the authorized contacts if the user is unresponsive to the action buttons and remains within the geographical boundary of the predetermined emergency facility after a specified time interval; and
enabling the user to designate exempt locations via the graphical user interface to suppress the alerts during specified periods.

17. The method of claim 16, wherein the boundary tool allows the user to define boundaries for specific hospitals across multiple states.

18. The method of claim 16, wherein the alert module integrates with a web-based dashboard to consolidate user data from the graphical user interface and track interactions with consultancy services.
